(19) United States
(12) Patent Application Publication
(10) Pub. No.: US 2025/0293450 A1
(43) Pub. Date: Sep. 18, 2025

(54) Conductive Terminal

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/079,467

(22) Filed: Mar. 14, 2025

(30) Foreign Application Priority Data
Mar. 15, 2024 (TW) 113202656

(51) Int. Cl. H01R 13/11; H01R 13/629

(52) U.S. Cl. CPC H01R 13/113; H01R 13/629

(57) ABSTRACT

A conductive terminal capable of transmitting signals in an electronic product. The conductive terminal allows a conductive component to join and comprises a terminal body, a guiding frame body, and a connecting arm. The connecting arm connects the guiding frame body and the terminal body to form a joining passage, wherein the guiding frame body guides the conductive component to join via the joining passage. When the conductive component joins, the connecting arm deforms to accommodate the shape of the conductive component, thereby reducing the resistance generated by the conductive terminal during the joining of the conductive component. This prevents the conductive component from locally pressing the conductive terminal, which could otherwise cause undesired local deformation of the conductive terminal, thereby enhancing the reliability of the electrical connector in which the conductive terminal is installed.

### CROSS-REFERENCE TO RELATED APPLICATIONS

This application claims the priority of Republic of China Patent Application No. 113202656 filed on Mar. 15, 2024, in the State Intellectual Property Office of the R.O.C., the disclosure of which is incorporated herein by reference.

### BACKGROUND OF THE INVENTION

### Field of the Invention

The present application relates to a conductive terminal and, more specifically, to a conductive terminal capable of avoiding localized improper deformation caused by localized compression.

### Descriptions of the Related Art

In general, electrical connectors and conductive components are indispensable parts of electronic products. Typically, a conductive component can join a conductive terminal of an electrical connector to transmit electrical signals. However, due to the trend of miniaturization in electrical connectors and their conductive terminals, the conductive terminal is prone to interfering with the joining of the conductive component, causing localized compression of the conductive terminal, which results in localized improper deformation. This, in turn, affects the reliability of signal transmission by the conductive terminal, leading to malfunction or even damage to the electronic product. Therefore, how to prevent the conductive terminal from interfering with the joining of the conductive component is an important criterion for evaluating the reliability of an electrical connector.

It should be noted that, for safety reasons, only electrical connectors with high reliability can be used in electronic products for aviation, maritime, railway, and road transportation applications.

In view of the above, how to provide a conductive terminal that solves the issue of existing miniaturized conductive terminals easily interfering with the joining of conductive components, thereby improving the reliability of electrical connectors, comprise become a technical challenge that the industry is eager to overcome.

### SUMMARY OF THE INVENTION

In view of the drawbacks of the prior art mentioned above, the present application provides a conductive terminal, comprising: A conductive terminal, wherein the conductive terminal provides for joining with a conductive component, the conductive terminal comprising: a terminal body, wherein the terminal body comprises a terminal internal space and a terminal joining structure; a guiding frame body, wherein the guiding frame body comprises a frame-shaped guiding structure; and a first connecting arm, wherein the first connecting arm connects the guiding frame body and the terminal body to form a part of a joining passage; wherein the frame-shaped guiding structure guides the conductive component to enter the terminal internal space via the joining passage and joins the terminal joining structure; and the first connecting arm comprises a first connecting arm body and a first connecting arm perforation, wherein the first connecting arm perforation penetrates through the first connecting arm body, weakening the structural strength of the first connecting arm, allowing the deformation degree of the first connecting arm to be as expected when the frame-shaped guiding structure guides the conductive component into the terminal internal space via the joining passage.

Preferably, the conductive terminal said above, wherein the guiding frame body further comprises a first frame wall, a third frame wall, and a fourth frame wall, wherein the first frame wall comprises a first frame wall body and is respectively connected to the third frame wall and the fourth frame wall to form a part of the frame-shaped guiding structure, the first connecting arm is connected to the first frame wall, and the first connecting arm perforation extends to and penetrates through the first frame wall body, weakening the structural strength of the first frame wall compared to the third frame wall and the fourth frame wall, so that when the frame-shaped guiding structure guides the conductive component, the deformation degree of the first frame wall is greater than the deformation degree of the third frame wall and the fourth frame wall.

Preferably, the conductive terminal said above, further comprising: a third abutting arm and a fourth abutting arm, wherein the third abutting arm is on the same side as the third frame wall, and the fourth abutting arm is on the same side as the fourth frame wall, and the third abutting arm and the e fourth abutting arm extend from the terminal body to respectively abut against Preferably, the conductive terminal said above, and the terminal joining structure comprises a third terminal joining substructure and a fourth terminal joining substructure, wherein the third terminal joining substructure and the fourth terminal joining substructure are disposed on the third abutting arm and the fourth abutting arm, respectively, and can respectively joins the conductive component.

Preferably, the conductive terminal said above, wherein the third abutting arm and the fourth abutting arm are elastic cantilevers.

Preferably, the conductive terminal said above, further comprising a discharge contact structure, wherein the discharge contact structure is disposed on the third frame wall or the fourth frame wall and can contact the conductive component to provide discharge during the guiding process of the frame-shaped guiding structure, wherein the discharge contact structure contacts the conductive component before the terminal joining structure joins the conductive component.

Preferably, the conductive terminal said above, wherein the discharge contact structure is a protruding structure.

Preferably, the conductive terminal said above, wherein the guiding frame body further comprises a second frame wall, wherein the second frame wall is respectively connected to the third frame wall and the fourth frame wall to form another part of the frame-shaped guiding structure; the conductive terminal further comprises: a second connecting arm, wherein the second connecting arm is on the same side as the second frame wall and joins the second frame wall and the terminal body to form another part of the joining passage; wherein the second connecting arm comprises a second connecting arm body and a second connecting arm gap, wherein the second connecting arm gap penetrates through the second connecting arm body, and the width of the second connecting arm gap is a second connecting arm gap width, wherein the width of the first connecting arm perforation is a first connecting arm perforation width, and the first connecting arm perforation width is greater than the second connecting arm gap width, thereby weakening the structural strength of the first connecting arm compared to the second connecting arm, allowing the deformation degree of the first connecting arm to be greater than the deformation degree of the second connecting arm when the frame-shaped guiding structure guides the conductive component.

Preferably, the conductive terminal said above, wherein the second frame wall comprises a second frame wall body, the second connecting arm gap extends to and penetrates through the second frame wall body, weakening the structural strength of the second frame wall compared to the third frame wall and the fourth frame wall, allowing the deformation degree of the second frame wall to be greater than the deformation degree of the third frame wall and the fourth frame wall when the frame-shaped guiding structure guides the conductive component.

Preferably, the conductive terminal said above, wherein, because the first connecting arm perforation width is greater than the second connecting arm gap width, the structural strength of the first frame wall is weaker than the structural strength of the second frame wall, allowing the deformation degree of the first frame wall to be greater than the deformation degree of the second frame wall when the frame-shaped guiding structure guides the conductive component.

Preferably, the conductive terminal said above, wherein the terminal joining structure comprises a first terminal joining substructure and a second terminal joining substructure, wherein the first terminal joining substructure is on the same side as the first frame wall, and the second terminal joining substructure is on the same side as the second frame wall, and the first terminal joining substructure is disposed on the first connecting arm, and the second terminal joining substructure is disposed on the second connecting arm, to respectively joins the conductive component.

Compared to prior art, the present application provides a conductive terminal capable of transmitting signals in an electronic product. The conductive terminal allows a conductive component to join and comprises a terminal body, a guiding frame body, and a connecting arm. The connecting arm connects the guiding frame body and the terminal body to form a joining passage, wherein the guiding frame body guides the conductive component to join via the joining passage. When the conductive component joins, the connecting arm deforms to accommodate the shape of the conductive component, thereby reducing the resistance generated by the conductive terminal during the joining of the conductive component. This prevents the conductive component from locally pressing the conductive terminal, which could otherwise cause undesired local deformation of the conductive terminal, thereby enhancing the reliability of the electrical connector in which the conductive terminal is installed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of a conductive terminal of the present application from a first viewing angle in an embodiment.

FIG. 2 is a three-dimensional schematic view of a conductive terminal of the present application from a second viewing angle in an embodiment.

FIG. 3 is a top schematic view of a conductive terminal of the present application in an embodiment.

FIG. 4 is a front schematic view of a conductive terminal of the present application in an embodiment.

FIG. 5 is a left-side schematic view of a conductive terminal of the present application in an embodiment.

FIG. 6 is a right-side schematic view of a conductive terminal of the present application in an embodiment.

FIG. 7 is a sectional schematic view of a portion of the conductive terminal shown in FIG. 4, taken along line A-A.

FIG. 8 is a three-dimensional schematic view of a conductive terminal of the present application from a first viewing angle in an embodiment.

FIG. 9 is a three-dimensional schematic view of a conductive terminal of the present application from a second viewing angle in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

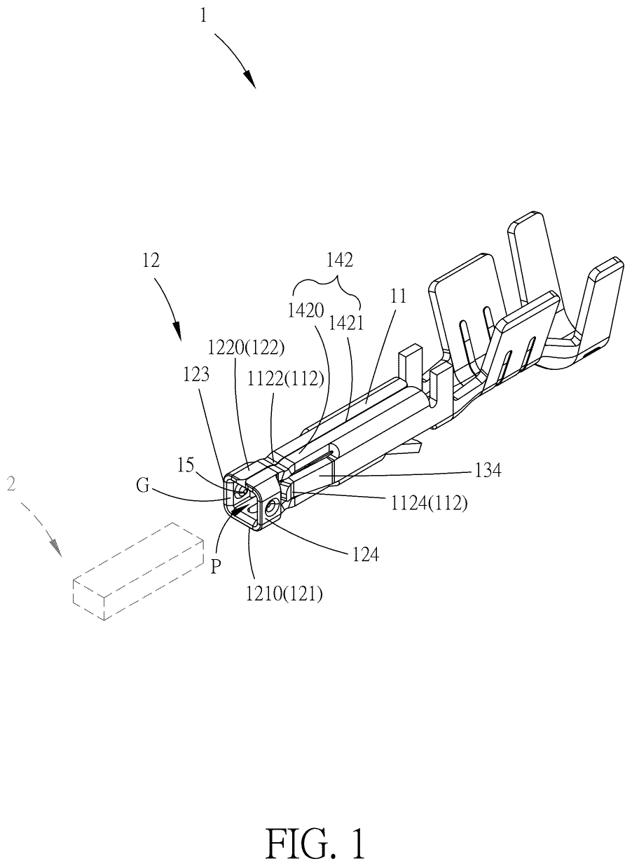

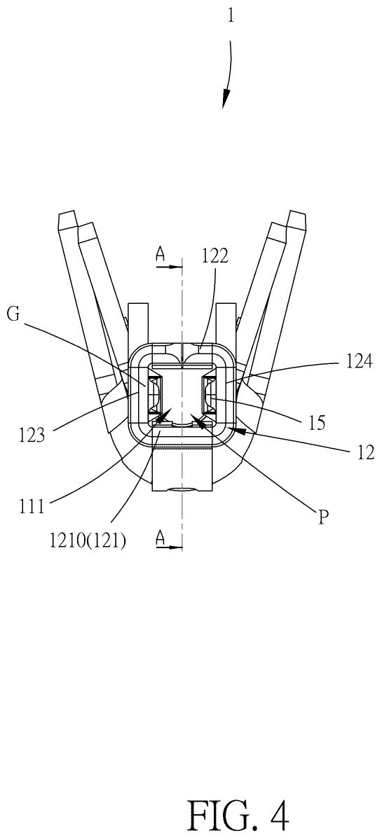

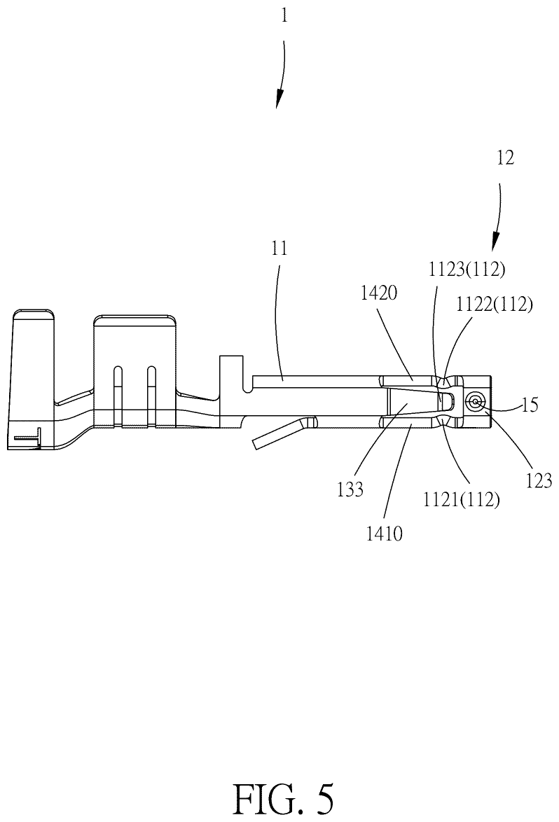

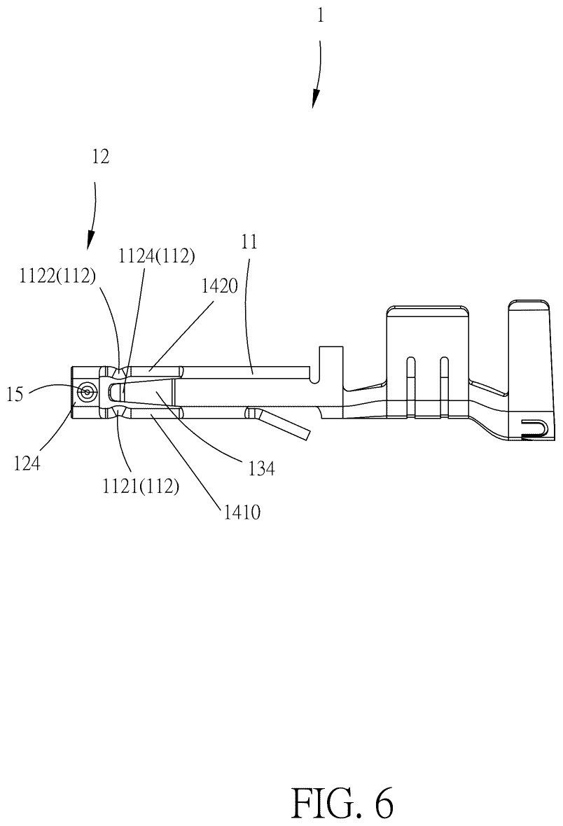

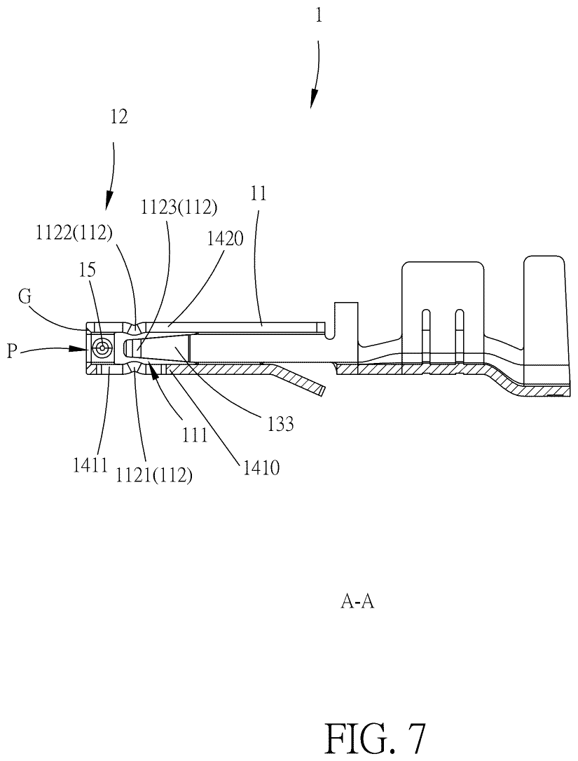

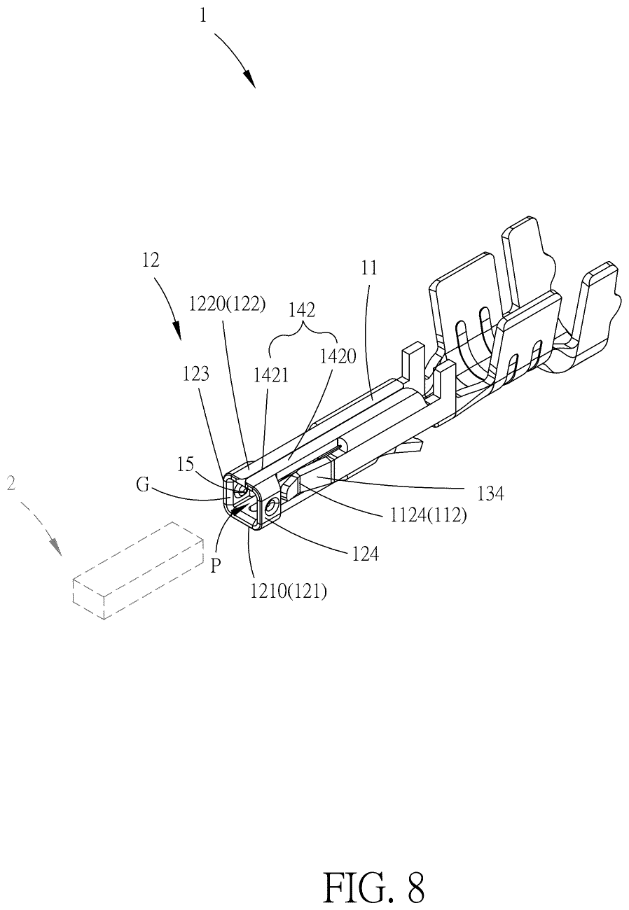

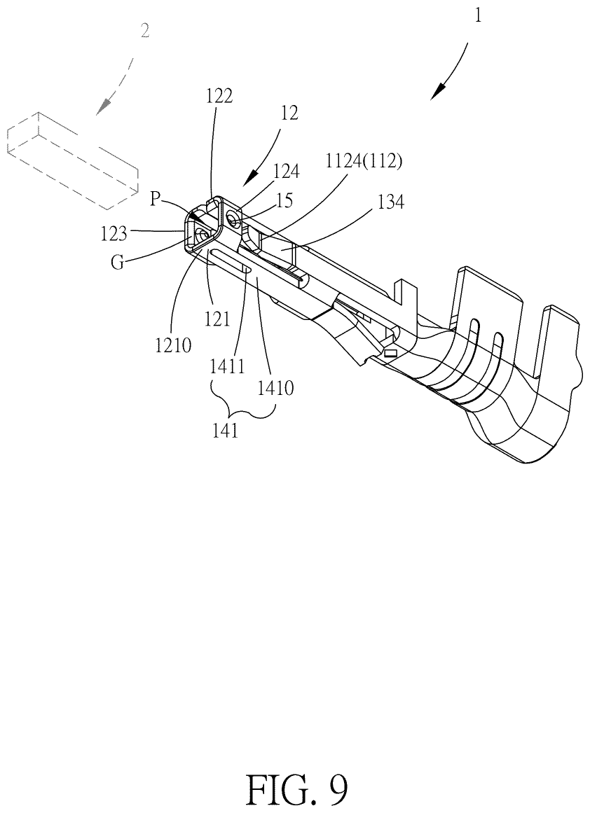

For a detailed description of the embodiments disclosed in the present application, please refer to FIGS. 1 to 9.

The present application provides a conductive terminal that enables the joining of a conductive component to transmit signals within an electronic product. The conductive terminal can be disposed in an electrical connector, and the conductive component can be inserted into the electrical connector to join the conductive terminal disposed therein for electrical signal transmission. The conductive component may be in the form of a conductive terminal or an electrical connector.

In the embodiments shown in FIGS. 1 to 9 of the present application, at least one conductive terminal 1 is disclosed, which enables the joining of a conductive component 2. The conductive terminal 1 comprises: a terminal body 11, a guiding frame body 12, a first connecting arm 141, and a second connecting arm 142.

It should be noted that the conductive terminal 1 may be integrally formed from a metal plate through bending and cutting processes.

In the above embodiments, the terminal body 11 comprises a terminal internal space 111 and a terminal joining structure 112. The guiding frame body 12 comprises a first frame wall 121, a second frame wall 122, a third frame wall 123, and a fourth frame wall 124. The first frame wall 121 is connected to the third frame wall 123 and the fourth frame wall 124, thereby ensuring the structural strength of the guiding frame body 12 as expected and forming part of a frame-shaped guiding structure G. Additionally, the second frame wall 122 is connected to the third frame wall 123 and the fourth frame wall 124, further ensuring the structural strength of the guiding frame body 12 and forming another part of the frame-shaped guiding structure G.

During the process of joining the conductive component 2 with the conductive terminal 1, the frame-shaped guiding structure G guides the conductive component 2 into the terminal internal space 111 and joins with the terminal joining structure 112. It should be noted that when the frame-shaped guiding structure G guides the conductive component 2, the shape of the conductive component 2 may come into contact with the guiding frame body 12, the first connecting arm 141, or the second connecting arm 142, causing deformation of the first frame wall 121, the second frame wall 122, the third frame wall 123, the fourth frame wall 124, the first connecting arm 141, or the second connecting arm 142. This allows the guiding frame body 12, the first connecting arm 141, or the second connecting arm 142 to accommodate the shape of the conductive component 2 through deformation, thereby preventing interference between the first frame wall 121, the second frame wall 122, the third frame wall 123, the fourth frame wall 124, the first connecting arm 141, or the second connecting arm 142 and the entry of the conductive component 2 into the terminal internal space 111. This reduces the resistance during the joining of the conductive terminal 1 with the conductive component 2, preventing localized compression of the conductive terminal 1 by the conductive component 2 that could lead to improper deformation of the conductive terminal 1, thereby enhancing the reliability of the electrical connector in which the conductive terminal 1 is installed.

However, the above description is not limiting. It should be noted that when the frame-shaped guiding structure G guides the conductive component 2, the shape of the conductive component 2 may not come into contact with the guiding frame body 12, the first connecting arm 141, and the second connecting arm 142, or it may only contact at least one of the guiding frame body 12, the first connecting arm 141, and the second connecting arm 142. Therefore, deformation of the guiding frame body 12, the first connecting arm 141, or the second connecting arm 142 is not necessarily required.

In the embodiments shown in FIGS. 1 to 3 and FIGS. 8 to 9 of the present application, the first connecting arm 141 is positioned on the same side as the first frame wall 121, and the second connecting arm 142 is positioned on the same side as the second frame wall 122. The first connecting arm 141 connects the first frame wall 121 with the terminal body 11, ensuring the structural strength of the conductive terminal 1 as expected and forming part of a joining passage P. The second connecting arm 142 connects the second frame wall 122 with the terminal body 11, ensuring the structural strength of the conductive terminal 1 as expected and forming another part of the joining passage P. It should be noted that the frame-shaped guiding structure G guides the conductive component 2 through the joining passage P into the terminal internal space 111 to joins the terminal joining structure 112.

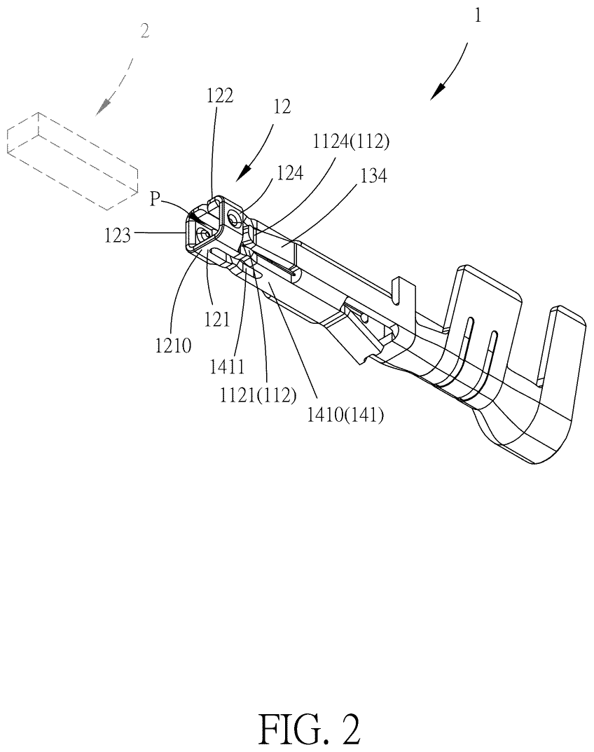

In the embodiments shown in FIGS. 2 to 3, FIGS. 7, and FIG. 9, the first connecting arm 141 comprises a first connecting arm body 1410 and a first connecting arm perforation 1411. The first connecting arm perforation 1411 extends through the first connecting arm body 1410, introducing a structural weakness. Thus, the first connecting arm perforation 1411 weakens the structural strength of the first connecting arm 141, ensuring that when the frame-shaped guiding structure G guides the conductive component 2 through the joining passage P into the terminal internal space 111, the deformation of the first connecting arm 141 is as expected.

In the above embodiments, the second connecting arm 142 comprises a second connecting arm body 1420 and a second connecting arm gap 1421. The second connecting arm gap 1421 extends through the second connecting arm body 1420, introducing a structural weakness. Thus, the second connecting arm gap 1421 weakens the structural strength of the second connecting arm 142, ensuring that when the frame-shaped guiding structure G guides the conductive component 2 through the joining passage P into the terminal internal space 111, the deformation of the second connecting arm 142 is as expected.

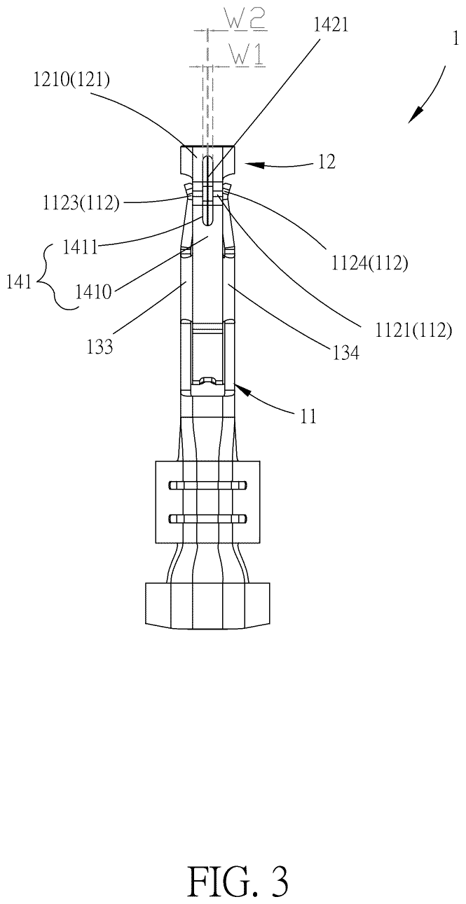

It should be noted that the width of the first connecting arm perforation 1411 is defined as a first connecting arm perforation width W1, while the width of the second connecting arm gap 1421 is defined as a second connecting arm gap width W2, as shown in FIG. 3. The first connecting arm perforation width W1 is greater than the second connecting arm gap width W2, making the structural strength of the first connecting arm 141 weaker than that of the second connecting arm 142. Consequently, when the frame-shaped guiding structure G guides the conductive component 2, the deformation of the first connecting arm 141 is greater than that of the second connecting arm 142 to accommodate the shape of the conductive component 2, ensuring that the frame-shaped guiding structure G smoothly guides the conductive component 2 into the terminal internal space 111 and joins with the terminal joining structure 112.

In the embodiments shown in FIGS. 1 to 4 and FIGS. 8 to 9, the first frame wall 121 comprises a first frame wall body 1210, and the second frame wall 122 comprises a second frame wall body 1220. The first connecting arm perforation 1411 extends to the first frame wall 121 and passes through the first frame wall body 1210, resulting in a structural weakness in the first frame wall 121. Consequently, the first connecting arm perforation 1411 weakens the structural strength of the first frame wall 121, making the structural strength of the first frame wall 121 weaker than that of the third frame wall 123 and the fourth frame wall 124. This configuration ensures that when the frame-shaped guiding structure G guides the conductive component 2, the degree of deformation of the second frame wall 122 is greater than that of the third frame wall 123 and the fourth frame wall 124.

Additionally, the second frame wall 122 comprises a second frame wall body 1220, and the second connecting arm gap 1421 extends to the second frame wall 122 and passes through the second frame wall body 1220, causing a structural weakness in the second frame wall 122. As a result, the second connecting arm gap 1421 weakens the structural strength of the second frame wall 122, making it weaker than the third frame wall 123 and the fourth frame wall 124. This ensures that when the frame-shaped guiding structure G guides the conductive component 2, the degree of deformation of the second frame wall 122 is greater than that of the third frame wall 123 and the fourth frame wall 124.

In the above embodiments, since the width W1 of the first connecting arm perforation is greater than the width W2 of the second connecting arm gap, the structural strength of the first frame wall 121 is weaker than that of the second frame wall 122. This configuration ensures that when the frame-shaped guiding structure G guides the conductive component 2, the degree of deformation of the first frame wall 121 is greater than that of the second frame wall 122. As a result, the deformation degree of the frame-shaped guiding structure G meets expectations, enabling the conductive component 2 to be smoothly guided into the terminal internal space 111 and joined with the terminal joining structure 112.

In the embodiments shown in FIGS. 1 to 3 and FIGS. 5 to 9 of this application, the conductive terminal 1 further comprises a third abutting arm 133 and a fourth abutting arm 134. The third abutting arm 133 is positioned on the same side as the third frame wall 123, and the fourth abutting arm 134 is positioned on the same side as the fourth frame wall 124, and they extend from the terminal body 11 into the terminal internal space 111, enabling to respectively abut against the conductive component 2 entering the terminal internal space 111. Correspondingly, the terminal joining structure 112 comprises a third terminal joining substructure 1123 and a fourth terminal joining substructure 1124. The third abutting arm 133 and the fourth abutting arm 134 respectively have free ends that can adapt to the shape and movement of the conductive component 2, while the third terminal joining substructure 1123 and the fourth terminal joining substructure 1124 are respectively disposed at the free ends of the third abutting arm 133 and the fourth abutting arm 134 to enable to be joined with the conductive component 2.

Optionally, the third terminal joining substructure 1123 and the fourth terminal joining substructure 1124 may be bending structures. The third abutting arm 133 and the fourth abutting arm 134 are elastic cantilevers, enabling to elastically deform to adapt to the conductive component 2 entering the terminal internal space 111 and elastically abut against it. This prevents the conductive component 2 from easily detaching after entering the terminal internal space 111, and also provides an elastic force to push the conductive component 2 into the appropriate position. This prevents local compression of the conductive terminal 1 by the conductive component 2, avoiding unintended deformation of the conductive terminal 1 and improving the reliability of the electrical connector incorporating the conductive terminal 1.

In the above embodiments, the terminal joining structure 112 comprises a first terminal joining substructure 1121 and a second terminal joining substructure 1122. As shown in FIGS. 1 to 3 and FIGS. 5 to 7, the first terminal joining substructure 1121 and the second terminal joining substructure 1122 are respectively disposed on the first connecting arm 141 and the second connecting arm 142, enabling to joins the conductive component 2 entering the terminal internal space 111 via the joining passage P. Optionally, the first terminal joining substructure 1121 and the second terminal joining substructure 1122 may be bending structures.

In the embodiments shown in FIGS. 1 and FIGS. 4 to 9 of this application, the conductive terminal 1 further comprises a discharge contact structure 15. The discharge contact structure 15 is disposed on the third frame wall 123 or the fourth frame wall 124. During the guiding process of the conductive component 2 by the frame-shaped guiding structure G, the discharge contact structure 15 contacts the conductive component 2. The discharge contact structure 15 makes contact with the conductive component 2 earlier than the terminal joining structure 112, thereby enabling the discharge contact structure 15 to provide discharge for the conductive component 2.

Optionally, the discharge contact structure 15 may be a protruding structure capable of contacting the conductive component 2 to facilitate tip discharge, thereby effectively preventing electrostatic discharge from entering the electronic product through the conductive terminal 1 and damaging internal circuits of the electronic product.

It should be noted that in the above embodiments, some components may be omitted. For example, in this application, the conductive terminal may only comprise a terminal body, a guiding frame body, and a first connecting arm. The terminal body comprises a terminal internal space and a terminal joining structure. The guiding frame body comprises a frame-shaped guiding structure. The first connecting arm joins the guiding frame body and the terminal body to form part of a joining passage. The frame-shaped guiding structure guides the conductive component into the terminal internal space via the joining passage and joins with the terminal joining structure. The first connecting arm comprises a first connecting arm body and a first connecting arm perforation, where the first connecting arm perforation passes through the first connecting arm body, weakening the structural strength of the first connecting arm. This ensures that when the frame-shaped guiding structure guides the conductive component into the terminal internal space via the joining passage, the deformation degree of the first connecting arm meets expectations.

In summary, this application provides a conductive terminal for signal transmission in electronic products. The conductive terminal allows for the joining of a conductive component and comprises a terminal body, a guiding frame body, and a connecting arm. The connecting arm joins the guiding frame body and the terminal body to form a joining passage, and the guiding frame body guides the conductive component for joining via the joining passage. When the conductive component is joined, the connecting arm deforms to adapt to the shape of the conductive component, thereby reducing the resistance generated by the conductive terminal during the joining process. This prevents local compression of the conductive terminal by the conductive component, avoiding unintended deformation and improving the reliability of the electrical connector incorporating the conductive terminal.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A conductive terminal, wherein the conductive terminal provides for joining with a conductive component, the conductive terminal comprising:
a terminal body, wherein the terminal body comprises a terminal internal space and a terminal joining structure;
a guiding frame body, wherein the guiding frame body comprises a frame-shaped guiding structure; and
a first connecting arm, wherein the first connecting arm connects the guiding frame body and the terminal body to form a part of a joining passage; wherein
the frame-shaped guiding structure guides the conductive component to enter the terminal internal space via the joining passage and joins the terminal joining structure; and
the first connecting arm comprises a first connecting arm body and a first connecting arm perforation, wherein the first connecting arm perforation penetrates through the first connecting arm body, weakening the structural strength of the first connecting arm, allowing the deformation degree of the first connecting arm to be as expected when the frame-shaped guiding structure guides the conductive component into the terminal internal space via the joining passage.

2. The conductive terminal of claim 1, wherein the guiding frame body further comprises a first frame wall, a third frame wall, and a fourth frame wall, wherein the first frame wall comprises a first frame wall body and is respectively connected to the third frame wall and the fourth frame wall to form a part of the frame-shaped guiding structure, the first connecting arm is connected to the first frame wall, and the first connecting arm perforation extends to and penetrates through the first frame wall body, weakening the structural strength of the first frame wall compared to the third frame wall and the fourth frame wall, so that when the frame-shaped guiding structure guides the conductive component, the deformation degree of the first frame wall is greater than the deformation degree of the third frame wall and the fourth frame wall.

3. The conductive terminal of claim 2, further comprising: a third abutting arm and a fourth abutting arm, wherein the third abutting arm is on the same side as the third frame wall, and the fourth abutting arm is on the same side as the fourth frame wall, and the third abutting arm and the e fourth abutting arm extend from the terminal body to respectively abut against the conductive component entering the terminal internal space; and
the terminal joining structure comprises a third terminal joining substructure and a fourth terminal joining substructure, wherein the third terminal joining substructure and the fourth terminal joining substructure are disposed on the third abutting arm and the fourth abutting arm, respectively, and can respectively joins the conductive component.

4. The conductive terminal of claim 3, wherein the third abutting arm and the fourth abutting arm are elastic cantilevers.

5. The conductive terminal of claim 2, further comprising a discharge contact structure, wherein the discharge contact structure is disposed on the third frame wall or the fourth frame wall and can contact the conductive component to provide discharge during the guiding process of the frame-shaped guiding structure, wherein the discharge contact structure contacts the conductive component before the terminal joining structure joins the conductive component.

6. The conductive terminal of claim 5, wherein the discharge contact structure is a protruding structure.

7. The conductive terminal of claim 2, wherein the guiding frame body further comprises a second frame wall, wherein the second frame wall is respectively connected to the third frame wall and the fourth frame wall to form another part of the frame-shaped guiding structure; the conductive terminal further comprises: a second connecting arm, wherein the second connecting arm is on the same side as the second frame wall and joins the second frame wall and the terminal body to form another part of the joining passage; wherein
the second connecting arm comprises a second connecting arm body and a second connecting arm gap, wherein the second connecting arm gap penetrates through the second connecting arm body, and the width of the second connecting arm gap is a second connecting arm gap width, wherein the width of the first connecting arm perforation is a first connecting arm perforation width, and the first connecting arm perforation width is greater than the second connecting arm gap width, thereby weakening the structural strength of the first connecting arm compared to the second connecting arm, allowing the deformation degree of the first connecting arm to be greater than the deformation degree of the second connecting arm when the frame-shaped guiding structure guides the conductive component.

8. The conductive terminal of claim 7, wherein the second frame wall comprises a second frame wall body, the second connecting arm gap extends to and penetrates through the second frame wall body, weakening the structural strength of the second frame wall compared to the third frame wall and the fourth frame wall, allowing the deformation degree of the second frame wall to be greater than the deformation degree of the third frame wall and the fourth frame wall when the frame-shaped guiding structure guides the conductive component.

9. The conductive terminal of claim 8, wherein, because the first connecting arm perforation width is greater than the second connecting arm gap width, the structural strength of the first frame wall is weaker than the structural strength of the second frame wall, allowing the deformation degree of the first frame wall to be greater than the deformation degree of the second frame wall when the frame-shaped guiding structure guides the conductive component.

10. The conductive terminal of claim 8, wherein the terminal joining structure comprises a first terminal joining substructure and a second terminal joining substructure, wherein the first terminal joining substructure is on the same side as the first frame wall, and the second terminal joining substructure is on the same side as the second frame wall, and the first terminal joining substructure is disposed on the first connecting arm, and the second terminal joining substructure is disposed on the second connecting arm, to respectively joins the conductive component.
